(19) United States
(12) Patent Application Publication
(10) Pub. No.: US 2005/0039393 A1
(43) Pub. Date: Feb. 24, 2005

(54) Floral sleeve having an arcuate upper end

(76) Inventor: Donald E. Weder, Highland, IL (US)

Correspondence Address: DUNLAP, CODDING & ROGERS P.C., PO BOX 16370, OKLAHOMA CITY, OK, 73113, US

(21) Appl. No.: 10/941,691

(22) Filed: Sep. 15, 2004

Related U.S. Application Data
(63) Continuation of application No. 10/806,984, filed on Mar. 23, 2004.
Application No. 10/806,984 is a continuation of application No. 10/437,151, filed on May 13, 2003.
Application No. 10/437,151 is a continuation of application No. 10/188,242, filed on Jul. 1, 2002, now Pat. No. 6,574,920.
Application No. 10/188,242 is a continuation of application No. 09/839,111, filed on Apr. 20, 2001, now Pat. No. 6,430,869.
Application No. 09/839,111 is a continuation-in-part of application No. 09/464,742, filed on Dec. 16, 1999, now Pat. No. 6,345,467.
Application No. 09/464,742 is a continuation-in-part of application No. 09/067,498, filed on Apr. 27, 1998, now Pat. No. 6,023,885.

(51) Int. Cl. A01G 5/00

(52) U.S. Cl. 47/41.01

(57) ABSTRACT

A plant packaging and covering system including a floral sleeve having a decorative pattern or color thereon. The sleeve may have a lower portion sized to cover a pot and an upper portion which can surround a plant disposed in the pot and which can be detached afterthe protective function of the upper portion is complete or which can be used to support the sleeve from a support device prior to use. The upper boundary of the decorative pattern or color has a configuration that is different from a configuration of the upper edge of the lower portion such that when the upper portion of the sleeve is removed, the upper edge of the lower portion of the sleeve has the appearance of having the configuration of the upper boundary of the decorative pattern or color.

### CROSS-REFERENCE TO RELATED APPLICATIONS

The present application is a continuation of U.S. Ser. No. 10/806,984, filed Mar. 23, 2004; which is a continuation of U.S. Ser. No. 10/437,151, filed May 13, 2003; which is a continuation of U.S. Ser. No. 10/188,242, filed Jul. 1, 2002, now U.S. Pat. No. 6,574,920; which is a continuation of U.S. Ser. No. 09/839,111, filed Apr. 20, 2001, now U.S. Pat. No. 6,430,869; which is a continuation-in-part of U.S. Ser. No. 09/464,742, filed Dec. 16, 1999, now U.S. Pat. No. 6,345,467; which is a continuation-in-part of U.S. Ser. No. 09/067,498, filed Apr. 27, 1998, now U.S. Pat. No. 6,023,885; the specifications of each of which are hereby expressly incorporated by reference herein.

### FIELD OF THE INVENTION

This invention generally relates to sleeves, and, more particularly, sleeves used to wrap floral groupings or flower pots containing floral groupings and/or mediums containing floral groupings, and methods of using same.

The present application has subject matter which is related to the disclosures of U.S. Pat. No. 5,625,979, and U.S. Pat. No. 5,572,851. The specification of each of these patents is hereby expressly incorporated by reference herein in its entirety.

### BRIEF DESCRIPTION OF THE DRAWINGS

FIG. 1 is an elevational view of a sleeve having a lower portion with a decorative pattern having a non-linear upper boundary and having an upper detachable portion constructed in accordance with the present invention.

FIG. 2 is a perspective view of a potted plant disposed within the opened sleeve of FIG. 1.

FIG. 3 is a perspective view of the sleeve of FIG. 1 and a pot after the upper portion of the sleeve has been removed from the lower portion of the sleeve.

FIG. 4 is an elevational view of another sleeve constructed in accordance with the present invention.

FIG. 5 is an elevational view of another sleeve constructed in accordance with the present invention.

FIG. 6 is an elevational view of another sleeve constructed in accordance with the present invention.

FIG. 7 is an elevational view of yet another sleeve constructed in accordance with the present invention.

FIG. 8 is an elevational view of yet another sleeve constructed in accordance with the present invention.

FIG. 9 is a perspective view of the sleeve of FIG. 8 when opened and with a pot disposed therein.

FIG. 10 is a perspective view of the opened sleeve of FIG. 8 having a pot disposed therein after the upper portion has been detached therefrom.

FIG. 11 is an elevational view of yet another sleeve constructed in accordance with the present invention.

FIG. 12 is an elevational view of another sleeve constructed in accordance with the present invention.

FIG. 13 is an elevational view of another sleeve constructed in accordance with the present invention.

FIG. 14 is an elevational view of another sleeve constructed in accordance with the present invention.

FIG. 15 is an elevational view of another sleeve constructed in accordance with the present invention.

FIG. 16 is a perspective view of a pot disposed within the opened sleeve of FIG. 15.

FIG. 17 is a perspective view of the sleeve and pot of FIG. 16 after the upper portion of the sleeve has been removed from the lower portion.

FIG. 18 is an elevational view of another sleeve constructed in accordance with the present invention.

FIG. 19 is an elevational view of another sleeve constructed in accordance with the present invention.

FIG. 20 is an elevational view of another sleeve constructed in accordance with the present invention.

FIG. 21 is an elevational view of another sleeve constructed in accordance with the present invention.

FIG. 22 is an elevational view of another sleeve constructed in accordance-with the present invention.

FIG. 23 is an elevational view of another sleeve constructed in accordance with the present invention.

FIG. 24 is an elevational view of another sleeve constructed in accordance with the present invention.

FIG. 25 is an elevational view of another sleeve constructed in accordance with the present invention.

FIG. 26 is an elevational view of another sleeve constructed in accordance with the present invention.

FIG. 27 is an elevational view of another sleeve constructed in accordance with the present invention.

FIG. 28 is an elevational view of another sleeve constructed in accordance with the present invention.

FIG. 28A is a perspective view of the sleeve of FIG. 28, when opened, and having a pot disposed therein.

FIG. 29 is an elevational view of another sleeve constructed in accordance with the present invention.

FIG. 30 is an elevational view of another sleeve constructed in accordance with the present invention.

FIG. 31 is an elevational view of another sleeve constructed in accordance with the present invention.

FIG. 32 is an elevational view of another sleeve constructed in accordance with the present invention.

FIG. 33 is an elevational view of another sleeve constructed in accordance with the present invention.

FIG. 34 is an elevational view of another sleeve constructed in accordance with the present invention.

FIG. 35 is an elevational view of another sleeve constructed in accordance with the present invention.

FIG. 36 is an elevational view of another sleeve constructed in accordance with the present invention.

FIG. 37 is an elevational view of another sleeve constructed in accordance with the present invention.

FIG. 38 is an elevational view of another sleeve constructed in accordance with the present invention.

FIG. 39 is an elevational view of another sleeve constructed in accordance with the present invention.

FIG. 40 is an elevational view of another sleeve constructed in accordance with the present invention.

### DESCRIPTION OF THE PREFERRED EMBODIMENTS

The present invention contemplates in a preferred version a preformed tubular sleeve for covering a pot having an upper rim, a lower end, and an outer peripheral surface. The preformed tubular sleeve (also referred to herein as sleeve) comprises a lower portion and may further comprise a detachable upper portion generally sized so as to surround and enclose a floral grouping in the pot.

The sleeve may form part of a plant package when used in conjunction with a pot disposed within the lower portion of the sleeve, the pot having a floral grouping disposed therein, and wherein the pot is substantially surrounded and encompassed by the lower portion of the sleeve and the floral grouping is substantially surrounded and encompassed and enclosed by the upper portion of the sleeve when it is present as a part of the sleeve.

Also, the lower portion of the sleeve may include a bonding material disposed on an inner peripheral surface thereof for bondingly connecting to a pot disposed therein; or the bonding material may be disposed on an outer peripheral surface thereof.

The lower portion of the sleeve may be constructed from a first material and the upper portion of the sleeve (when present) may be constructed from a second material different from the first material.

The sleeve is initially formed in a flattened condition and may be expanded to an open condition at any time-prior to use, shipment, or sale.

The sleeve may include vertical or horizontal expansion elements, preferably comprising a plurality of folds. The folds may extend entirely circumferentially about the lower portion, or may extend only partially circumferentially about the lower portion of the sleeve, or may extend into a skirt portion of the lower portion. The expansion elements preferably function to cause the lower portion of the sleeve to conform to the shape of a pot when a pot is disposed within the sleeve. The folds or expansion elements may extend the entire length from the lower end of the lower portion to the upper end of the sleeve or may extend only an intermediate distance therebetween.

The expansion elements may be a plurality of vertical pleats, a plurality of vertical folds each having a z-shaped cross section, a plurality of vertical accordion-type folds, or other similar types of expandable forms. Examples of such expansion elements are disclosed in U.S. Pat. No. 5,625,979, the specification of which is hereby expressly incorporated by reference herein in its entirety.

These embodiments and others of the present invention are now described in more detail below. It will be appreciated that the examples provided herein are not intended to limit the scope and extent of the claimed invention but are only intended to exemplify various embodiments of the invention contemplated herein.

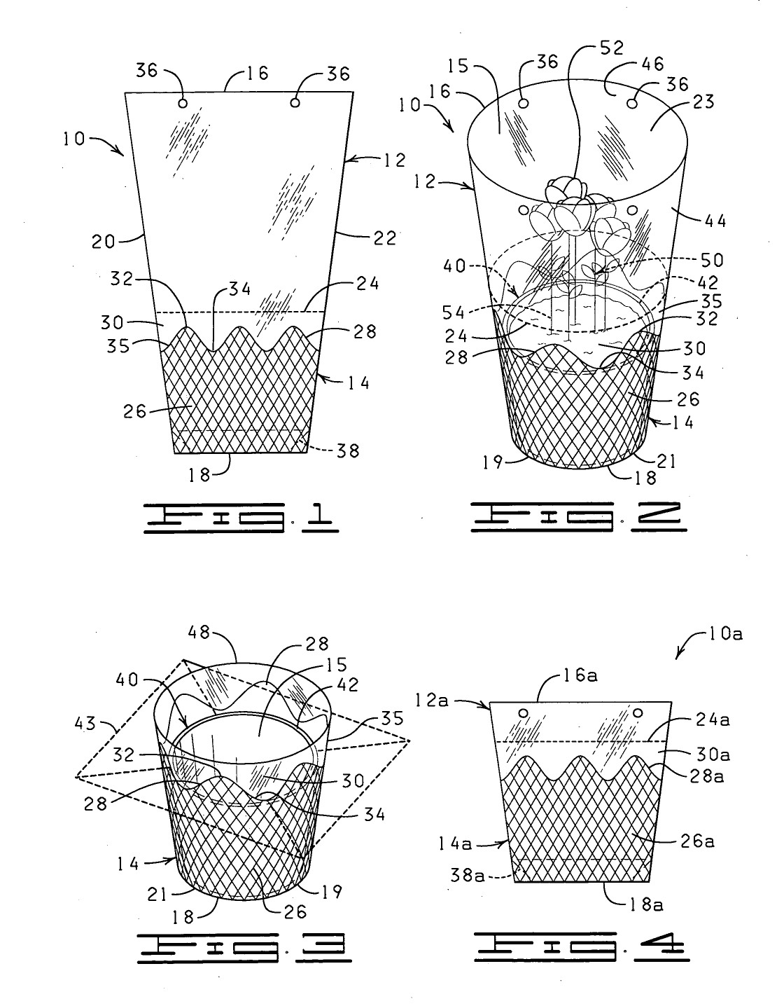

### The Embodiments and Methods of Use of FIGS. 1-7

Shown in FIGS. 1-3 and designated therein by the general reference numeral 10 is a flexible preformed tubular sleeve (also referred to simply as a “sleeve”) of unitary construction. The sleeve 10 preferably initially is in a flattened condition and is openable in the form of a tube having an open bottom, a closed bottom, or a closed bottom having drainage holes.

The sleeve 10 in a particularly preferred version has an upper portion 12, a lower portion 14, an inner retaining space 15, an upper end 16, and a lower end 18, and in its flattened state has a first side 20 and a second side 22. The sleeve 10 has an opening 23 at the upper end 16 and is, in a preferred embodiment, closed with a bottom 19 at the lower end 18. The bottom 19 has a perimeter 21. A portion of the lower end 18 may have one or more gussets 38 therein constructed in a manner well known to one of ordinary skill in the art as shown in FIG. 1, for permitting a bottom of an object, such as a pot 40, to be disposed into the inner retaining space 15 of the lower portion 14 of the sleeve 10. Gussets 38, and the construction of gussets, are well known in the art of constructing flexible containers, therefore further discussion of gussets or their construction is not deemed necessary herein. Further, the lower end 18 may be constructed in the manner shown in copending U.S. Ser. No. 09/401,771, the specification of which is hereby expressly incorporated herein in its entirety. FIG. 5, discussed in more detail hereinbelow, shows a sleeve 10b formed without a gusset in a lower end 18b thereof. Any sleeve described herein may be constructed with or without the gusset 38 therein.

The sleeve 10 is generally frusto-conically shaped, but the sleeve 10 may be, by way of example but not by way of limitation, cylindrical, frusto-conical, a combination of both frusto-conical and cylindrical, or any other shape, such as square or rectangular, as long as the sleeve 10 functions as described herein as noted above. Prior to shipment to the user, or prior to use by the user, the sleeve 10 may be formed in an opened frusto-conical configuration, for example, for shipment in a nested bunch. Further, the sleeve 10 may comprise any shape, whether geometric, non-geometric, symmetrical and/or fanciful as long is it functions in accordance with the present invention. The sleeve 10 may also be equipped with a drainage element (e.g., one or more holes) in the lower end 18 or ventilation holes (not shown) or can be made from permeable or impermeable materials.

The material from which the sleeve 10 is constructed preferably has a thickness in a range from about 0.1 mil to about 30 mils. Often, the thickness of the sleeve 10 is in a range from about 0.5 mil to about 10 mils. Preferably, the sleeve 10 has a thickness in a range from about 1.0 mil to about 5 mils. More preferably, the sleeve 10 is constructed from a material which is flexible, semi-rigid, rigid, or any combination thereof. The sleeve 10 may be constructed of a single layer of material or a plurality of layers of the same or different types of materials. Any thickness of the material may be utilized as long as the material functions in accordance with the present invention as described herein. The layers of material comprising the sleeve 10 may be connected together or laminated or may be separate layers. Such materials used to construct the sleeve 10 are described in U.S. Pat. No. 5,111,637, entitled “Method For Wrapping A Floral Grouping” issued to Weder et al., on May 12, 1992, which is hereby expressly incorporated herein by reference. Any thickness of material may be utilized in accordance with the present invention as long as the sleeve 10 may be formed as described herein, and as long as the formed sleeve 10 may contain at least a portion of the pot 40 and/or a floral grouping 50, as described herein. Additionally, an insulating material such as bubble film, preferable as one of two or more layers, can be utilized in order to provide additional protection for the item, such as the floral grouping 50, contained therein.

In one embodiment, the sleeve 10 may be constructed from a sheet comprising two polypropylene films. The sheets of polypropylene film used in the construction of the sleeve 10 may be connected together or laminated or may be separate layers. In an alternative embodiment, the sleeve 10 may be constructed from only one of the polypropylene films.

The sleeve 10 is constructed from any suitable material that is capable of being formed into the sleeve 10 and wrapped about the pot 40 and the floral grouping 50 disposed therein. Preferably, the material comprises paper (untreated or treated in any manner), metal foil, polymeric film, non-polymeric film, fabric (woven or nonwoven or synthetic or natural), cardboard, fiber, cloth, burlap, or laminations or combinations thereof.

The term “polymeric film” means a synthetic polymer such as, polypropylene or a naturally occurring polymer such as cellophane. A polymeric film is relatively strong and not as subject to tearing (substantially non-tearable), as might be the case with paper or foil.

The material used to construct the sleeve 10 may vary in color and may consist, for example, of designs or decorative patterns which are printed, etched, and/or embossed thereon using inks or other printing materials. An example of an ink which may be applied to the surface of the material is described in U.S. Pat. No. 5,147,706, entitled “Water Based Ink On Foil And/Or Synthetic Organic Polymer” issued to Kingman on Sep. 15, 1992, and which is hereby expressly incorporated herein by reference.

In addition, the material used to construct the sleeve 10 may have various colorings, coatings, flocking and/or metallic finishes, or other decorative surface ornamentation applied separately or simultaneously or may be characterized totally or partially by pearlescent, translucent, transparent, iridescent, neon, or the like, qualities. The material may further comprise, or have applied thereto, one or more scents. Each of the above-named characteristics may occur alone or in combination and may be applied to the upper and/or lower surface of the material comprising the sleeve 10. Moreover, portions of the material used in constructing the sleeve 10 may vary in the combination of such characteristics. The material utilized for the sleeve 10 itself may be opaque, translucent, transparent, or partially clear or tinted transparent.

The term “floral grouping” as used herein means cut fresh flowers, artificial flowers, a single flower or other fresh and/or artificial plants or other floral materials and may include other secondary plants and/or ornamentation or artificial or natural materials which add to the aesthetics of the overall floral grouping. The floral grouping preferably comprises a bloom or foliage portion and a stem portion. Further, the floral grouping may comprise a growing potted plant having a root portion (not shown) as well. However, it will be appreciated that the floral grouping may consist of only a single bloom or only foliage, or a botanical item (not shown), or a propagule (not shown). The term “floral grouping” may be used interchangeably herein with both the terms “floral arrangement” and “potted plant”. The term “floral grouping” may also be used interchangeably herein with the terms “botanical item” and/or “propagule.”

The term “growing medium” when used herein means any liquid, solid or gaseous material used for plant growth or for the cultivation of propagules, including organic and inorganic materials such as soil, humus, perlite, vermiculite, sand, water, and including the nutrients, fertilizers or hormones or combinations thereof required by the plants or propagules for growth. The term “botanical item” when used herein means a natural or artificial herbaceous or woody plant, taken singly or in combination. The term “botanical item” also means any portion or portions of natural or artificial herbaceous or woody plants including stems, leaves, flowers, blossoms, buds, blooms, cones, or roots, taken singly or in combination, or in groupings of such portions, such as bouquets or floral groupings.

The term “propagule” when used herein means any structure capable of being propagated or acting as an agent of reproduction including seeds, shoots, stems, runners, tubers, plants, leaves, roots or spores.

In accordance with the present invention, a bonding material (not shown) may be disposed on a portion of the sleeve 10 to assist in holding the sleeve 10 to the pot 40 having the floral grouping 50 therein when the pot 40 is disposed within the sleeve 10 or to assist in closing or sealing a portion of the sleeve 10 or in adhering the sleeve 10 to the pot 40 after the pot 40 has been disposed therein, as disclosed in U.S. Pat. Nos. 5,625,979, and 5,493,809, the specifications of which are hereby expressly incorporated herein in their entirety.

As noted above, the sleeve 10, in one embodiment, is demarcated into the upper portion 12 and the lower portion 14. The lower portion 14 of the sleeve 10 is generally sized to contain the pot 40. The upper portion 12 of the sleeve 10 may be sized to substantially surround and enclose the floral grouping 50 contained within the pot 40 disposed within the lower portion 14 of the sleeve 10, or may surround and enclose only a portion of the floral grouping 50, as explained in more detail below.

In a preferred embodiment, the sleeve 10 is demarcated into the upper portion 12 and the lower portion 14 by a detaching element 24, which may be a line of perforations, for enabling the detachment of the upper portion 12 of the sleeve 10 from the lower portion 14 of the sleeve 10. In the present version, the perforations 24 extends circumferentially across the sleeve 10 from the first side 20 to the second side 22. Although the upper portion 12 and the lower portion 14 are shown as detachable via the detaching element 24, any detaching element, or combination of elements, or features, such as, but not by way of limitation, perforations, tear strips, zippers, and any other devices or elements of similar nature known in the art, or any combination thereof, which enable the tearing away or detachment of one object from another may be used. Therefore, while perforations are particularly shown and described in detail herein as the detaching element 24, it will be understood that tear strips, zippers, or any other “detaching elements” known in the art, or any combination thereof, could be substituted therefore and/or used therewith as long as they functioned in accordance with the present invention.

The upper portion 12 of the sleeve 10 may also have an additional vertical detaching element (not shown) comprising a plurality of vertical perforations for facilitating removal of the upper portion 12.

It will be understood by a person of ordinary skill in the art that equipment and devices for forming floral sleeves are commercially available, and are well known to a person of ordinary skill in the art, e.g., see U.S. Pat. No. 5,496,251, the specification of which is hereby expressly incorporated herein by reference. For example, the sleeves described herein may be formed by intermittently advancing two separate webs, one or two webs preformed in the form of a tube, or a single web folded double and sealing the longitudinal sides and bottom of the two facing panels then cutting the sleeve thus formed from the webs or web. Machines which can form sleeves from such single webs or pairs of webs are well within the knowledge of one of ordinary skill in the art.

It should also be noted that for all versions of sleeves described herein, it may be desirable to have a release material or cover strip covering the adhesive or cohesive bonding material, when a bonding material is disposed on any portion of the sleeve, for preventing the bonding material from bonding to another surface until the desired time. Further, in each of the cases described herein wherein the sleeve 10 (or other sleeves described herein) is applied to the pot 40, the sleeve 10 may be applied thereto either by depositing the pot 40 downwardly into the inner retaining space 15 of the sleeve 10, or the sleeve 10 may be brought upwardly about the pot 40 from below the pot 40. The pot 40 has an upper rim 42 which is in a plane 43. The plane 43 of the upper rim 42 is substantially parallel to the perimeter 21 of the bottom 19 of the sleeve 10.

It should be further noted that various features of the versions of the present invention, such as closure bonding areas, support extensions, handles, additional perforations, drainage holes, ventilation holes, and combinations of material may be used alone or in combination as elements of any of the embodiments described above herein. Therefore, further discussion of the specific methods of construction of the sleeves described herein is not deemed necessary.

As noted above, the sleeve 10 includes the detaching element 24 which extends generally horizontally from the first side 20 to the second side 22 and which enables the upper portion 12 to be separated from the lower portion 14. The lower portion 14 includes a decorative pattern (or decorative design) 26 which may be printed on the sleeve 10, attached to the sleeve 10, or inherent in the sleeve 10 in any manner thereon (for example, as a color or laminate), which forms a non-linear upper boundary 28 on the sleeve 10. The portion of the sleeve 10 between the detaching element 24 and the non-linear upper boundary 28 of the decorative pattern 26 is clear and thus constitutes a clear zone 30 of the lower portion 14 of the sleeve 10. The non-linear upper. boundary 28, in a preferred embodiment, comprises a series of peaks 32 which alternate with troughs 34. The peaks 32 are preferably of equal height, but may be of varying heights as discussed elsewhere herein. The portion of the sleeve 10 which is designed to extend above the upper rim 42 of the pot 40 is designated as a skirt portion 35 of the lower portion 14 of the sleeve 10. The decorative pattern 26 may be a solid color, or multicolored print, or may be comprised of a plurality of individual patterns, such as a floral print composed of a pattern of leaves and blossoms, or may be a separate material attached to the lower portion 14. The non-linear upper boundary 28 may be a distinct demarcation between the clear zone 30 and the decorative pattern 26, or may be a less definite boundary (for example, comprising edges of a floral print, but which when viewed from a distance still provides the sleeve 10 with an appearance of having a non-linear upper boundary 28). The decorative pattern 26 may cover all, or just a portion, of the lower portion 14 below the clear zone 30. The peaks 32 are preferably within about 0.0 mm to about 25 mm of the detaching element 24 and the troughs 34 are generally about 10 mm to about 60 mm below the detaching element 24. These distances are not absolute and the peaks 32 and troughs 34 of the non-linear upper boundary 28 may be lesser or greater than the distances listed above.

As shown in herein the non-linear upper boundary 28 of the decorative pattern 26 preferably comprises a curved pattern, for example, similar to a sine wave. However, the non-linear configuration of the non-linear upper boundary 28 of the decorative pattern 26 is not meant to be limited to such a curved design and may be constructed in any number of other non-linear patterns, for example as shown in FIGS. 12A-12D of U.S. Ser. No. 09/067,498, the specification and drawings of which are hereby expressly incorporated herein by reference. Notable non-linear patterns which may be used include boundaries which have crenate, inverted crenate, crenelate or crenulate shapes. One of ordinary skill in the art will understand these are but a few of the patterns that the detaching element may form and one of ordinary skill could contemplate many other suitable non-linear patterns.

The sleeve 10 may have apertures 36 in a portion thereof for enabling the sleeve 10 to be supported from a support device such as a wicket (not shown).

The sleeve 10 can be used to cover a potted plant. In FIG. 2 the sleeve 10 is shown in an opened condition disposed about the pot 40 with the upper rim 42 and having the floral grouping 50 disposed therein. The-floral grouping extends vertically a distance above the upper rim 42 of the pot 40. The floral grouping 50 has an upper portion 52 and a stem portion 54 which extends from the pot 40. As shown in the opened condition in FIG. 2, the sleeve 10 has an outer peripheral surface 44 and an inner peripheral surface 46. In a preferred embodiment, as shown in FIG. 2, the upper portion 12 is sized to substantially surround and encompass the upper portion 52 of the floral grouping 50.

When the upper portion 12 of the sleeve 10 is removed from the lower portion 14 by detaching along the detaching element 24, the lower portion 14 of the sleeve 10 is left with an upper edge 48 which is more or less straight and which is disposed a distance above the upper rim 42 of the pot 40 (FIG. 3). Although the upper edge 48 of the lower portion 14 is substantially straight, the lower portion 14 is given the illusion of having a non-linear upper edge due to the conspicuousness of the non-linear upper boundary 28 of the decorative pattern 26 and the relative transparency and thus the invisibility, for all intents and purposes, of the clear zone 30. One advantage of having a generally straight detaching element 24 disposed a distance above the upper boundary 28 is that if the tear line is not torn exactly along the detaching element 24, the decorative nature of the upper boundary 28 of the decorative pattern 26 is not marred.

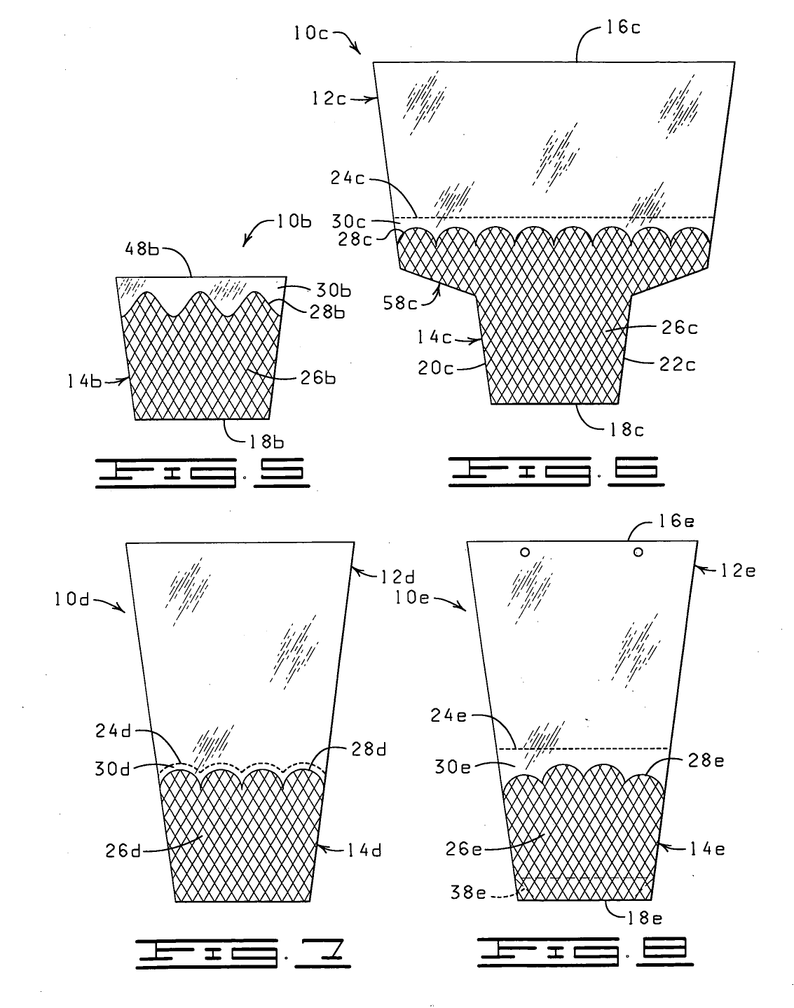

Shown in FIG. 4 is an alternative embodiment of the present invention. Sleeve 10a is substantially similar to sleeve 10, except for the size of an upper portion 12a. The upper portion 12a is detachable from a lower portion 14a which has a decorative pattern 26a which has a non-linear upper boundary 28a. A detaching element 24a (a line of perforations) is disposed between the upper portion 12a and the lower portion 14a. As with the sleeve 10, the area of the lower portion 14a disposed between the detaching element 24a and the upper boundary 28a of the decorative pattern 26a constitutes a clear zone 30a. The sleeve 10a has an upper end 16a and a lower end 18a and may optionally comprise a gusset 38a therein. Contrary to the upper portion 12 of sleeve 10, the upper portion 12a of sleeve 10a is not sized to substantially surround and enclose a floral grouping. Rather, the upper portion 12a serves to support the sleeve 10a from a support device, such as a wicket (not shown), wherein a plurality of sleeves 10a can be supported together in the same manner as a plurality of sleeves 10 can be supported. When the upper portion 12a is separated from the lower portion 14a via the detaching element 24a, and the lower portion 14a is disposed about the pot 40, the lower portion 14a appears substantially the same as the lower portion 14 of the sleeve 10 shown in FIG. 3 after the upper portion 12 has been removed.

Shown in FIG. 5 is an alternative embodiment of the present invention. Sleeve 10b is substantially similar to sleeve 10 except the sleeve 10b does not include an upper portion detachable from a lower portion 14b. Sleeve 10b includes a decorative pattern 26b having a non-linear upper boundary 28b. The sleeve 10b has a clear zone 30b between the upper boundary 28b. of the decorative pattern 26b and an upper edge 48b of the sleeve 10b. When opened and placed about a pot, the sleeve 10b appears substantially the same as the embodiment of sleeve 10 shown in FIG. 3 after the upper portion 12 has been removed.

Shown in FIG. 6 is a sleeve 10c which is substantially similar to the sleeve 10, comprising an upper portion 12c, a lower portion 14c, an upper end 16c, a lower end 18c, a substantially horizontal detaching element 24c (line of perforations) between the upper portion 12c and the lower portion 14c, a decorative pattern 26c having a non-linear upper boundary 28c and a clear zone 30c between the detaching element 24c and the upper boundary 28c of the decorative pattern 26c. Sleeve 10c differs from sleeve 10 by having an outwardly-extending skirt portion 58c which extends angularly away from tapered first and second sides 20c and 22c of the lower portion 14c, such that when the upper portion 12c is detached from the lower portion 14c and a pot is disposed in the lower portion 14c, the skirt portion 58c extends at an angle away from the lower portion 14c.

Shown in FIG. 7 is a sleeve 10d which is substantially similar to the sleeve 10 shown in FIG. 1. The sleeve 10d has a decorative pattern 26d having a non-linear upper boundary 28d, and has a detaching element 24d disposed between an upper portion 12d and a lower portion 14d, and. as a clear zone 30d between the upper boundary 28d of the decorative pattern 26d and the detaching element 24d. Sleeve 10d differs from sleeve 10 primarily in that the detaching element 24d has a pattern which generally corresponds to the curvature of the upper boundary 28d of the decorative pattern 26d. The clear zone 30d may be negligible or non-existent.

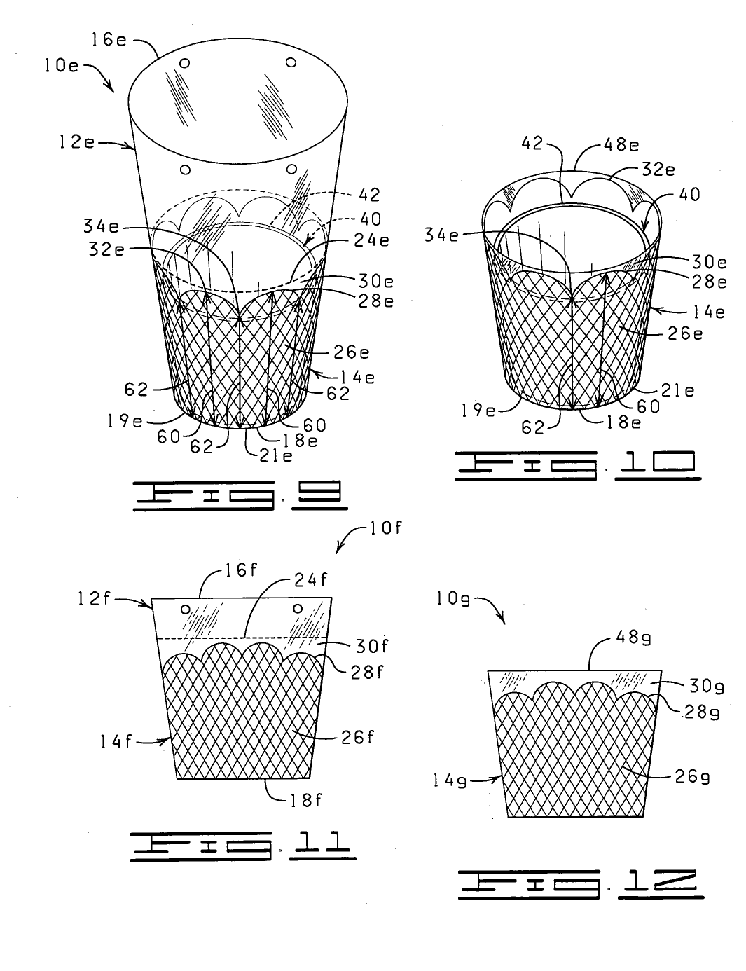

FIGS. 8-14

Shown in FIGS. 8-10 is a sleeve 10e which is substantially the same as sleeve 10 except for a difference in the position of a non-linear upper boundary of a decorative pattern thereon. As with sleeve 10, sleeve 10e has an upper portion 12e, a lower portion 14e, and a detaching element 24e therebetween. The sleeve 10e further includes an upper end 16e, a lower end 18e, a decorative pattern 26e on the lower portion 14e, a non-linear upper boundary 28e in the decorative pattern 26e, and a clear zone 30e between the detaching element 24e and the non-linear upper boundary 28e. The sleeve 10e may optionally further have a gusset 38e therein. The non-linear upper boundary 28e of the decorative pattern 26e is configured on the lower portion 14e such that when the sleeve 10e is in the open position (for example when disposed about the pot 40), each peak 32e of the non-linear upper boundary 28e is disposed a substantially equal peak vertical distance 60 from a perimeter 21e of a bottom 19e of the opened sleeve 10e, and each trough 34e of the non-linear upper boundary 28e is disposed a substantially equal trough vertical distance 62 from the perimeter 21e of the bottom 19e of the opened sleeve 10e, as shown in FIGS. 9 and 10. Where used herein, the term “substantially equal” vertical distance means that when viewed from a typical viewer perspective, the peaks 32e appear to be about the same height to a viewer and the troughs 34e appear to be about the same height to a viewer.

When the upper portion 12e of sleeve 10e is removed from the lower portion 14e by detaching along the detaching element 24e, the lower portion 14e is left with a more or less straight upper edge 48e (FIG. 10) which is disposed a distance above the upper rim 42 of the pot 40. Although the upper edge 48e of the lower portion 14e is generally straight, the lower portion 14e is given the illusion of having a non-linear upper edge due to the conspicuousness of the non-linear upper boundary 28e of the decorative pattern 26e and the relative transparency, thus invisibility, of the clear zone 30e in a manner similar to that shown for sleeve 10 in FIG. 3.

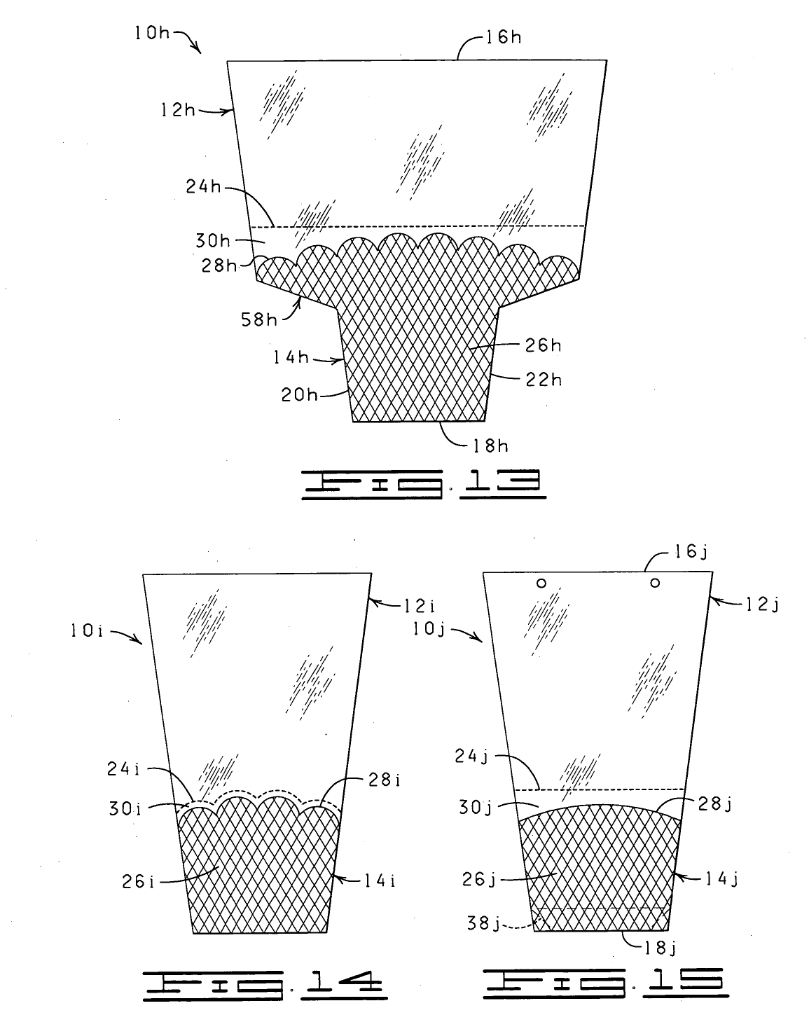

Shown in FIG. 11 is an alternative embodiment of the present invention. Sleeve 10f is basically the same as sleeve 10e, except for the size of an upper portion 12f. The upper portion 12f is detachable from a lower portion 14f which includes thereon a decorative pattern 26f having a non-linear upper boundary 28f. A detaching element 24f is disposed between the upper portion 12f and the lower portion 14f. As with sleeve 10e, a clear zone 30f of the lower portion 14f is disposed between the detaching element 24f and the upper boundary 28f of the decorative pattern 26f. The sleeve 10f has an upper end 16f and a lower end 18f and may optionally include a gusset therein, as discussed in detail above.

As opposed to the upper portion 12e of sleeve 10e, the upper portion 12f of sleeve 10f is not sized to substantially surround and enclose a floral grouping. Rather, the primary function of the upper portion 12f is to support the sleeve 10f from a support device such as a wicket (not shown) wherein a plurality of sleeves 10f can be supported together in the same manner as a plurality of sleeves 10e can be supported. When the upper portion 12f is separated from the lower portion 14f via a detaching element 24f, and the lower portion 14f is disposed about a pot, the decorative cover formed from the lower portion 14f appears substantially the same as the embodiment of the sleeve 10e shown in FIG. 10.

Shown in FIG. 12 is an alternative embodiment of the present invention. Sleeve 10g is basically the same as sleeve 10e except sleeve 10g does not include an upper portion detachable from a lower portion 14g. Sleeve 10g includes a decorative pattern 26g having a non-linear upper boundary 28g. The sleeve 10g has a clear zone 30g between the upper boundary 28g of the decorative pattern 26g and an upper edge 48g of the sleeve 10g. When opened and placed about a pot, sleeve 10g appears substantially the same as the embodiment of sleeve 10e shown in FIG. 10 after the upper portion 12e has been detached.

Shown in FIG. 13 is a sleeve 10h which is substantially the same as sleeve 10e, comprising an upper portion 12h, a lower portion 14h, an upper end 16h, a lower end 18h, a more or less straight detaching element 24h between the upper portion 12h and the lower portion 14h, a decorative pattern 26h having a non-linear upper boundary 28h and a clear zone 30h between the detaching element 24h and the upper boundary 28h of the decorative pattern 26h. Sleeve 10h differs from sleeve 10e by having an outwardly-extending skirt portion 58h which extends away from tapered first and second sides 20h and 22h of the lower portion 14h such that when the upper portion 12h is detached from the lower portion 14h and a pot is disposed in the lower portion 14h, the skirt portion 58h extends at an angle away from the lower portion 14h.

Shown in FIG. 14 is a sleeve 10i which is similar to the sleeve 10e shown in FIG. 8. The sleeve 10i has a decorative pattern 26i having a non-linear upper boundary 28i, and has a detaching element 24i disposed between an upper portion 12i and a lower portion 14i, and has a clear zone 30i between the non-linear upper boundary 28i of the decorative pattern 26i and the detaching element 24i. Sleeve 10i differs from sleeve 10e primarily in that the detaching element 24i has a pattern which generally corresponds to the curvature of the non-linear upper boundary 28i. The clear portion 30i, therefore, may be negligible or non-existent.

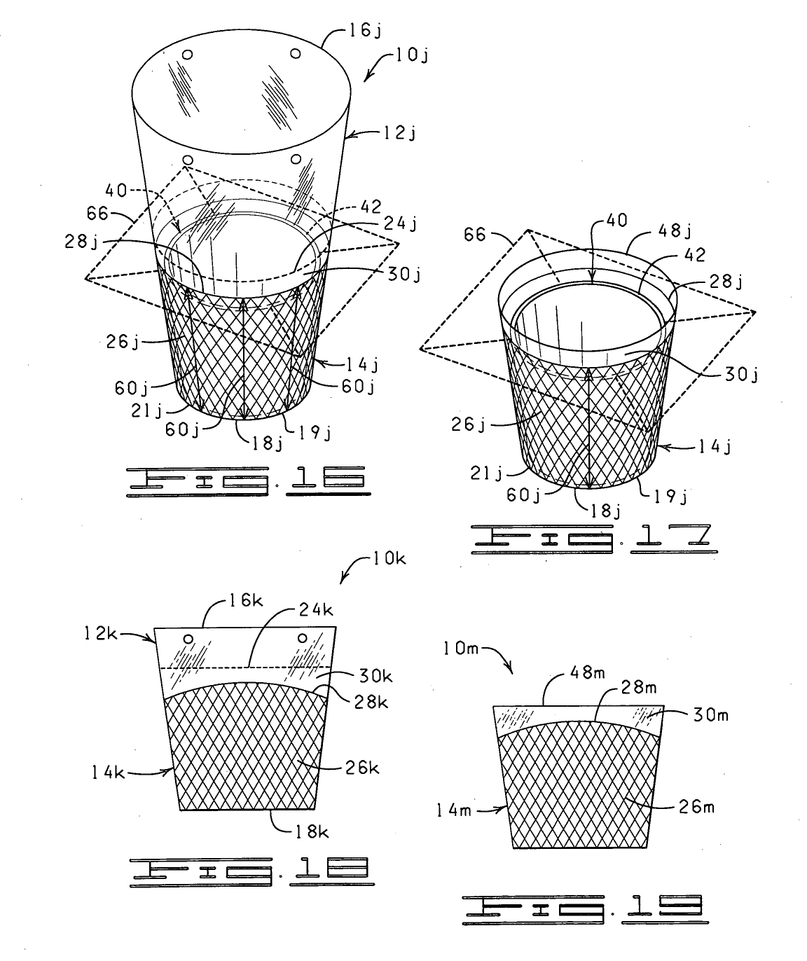

FIGS. 15-21

Shown in FIGS. 15-17 is a sleeve 10j which is basically the same as sleeve 10e except for a difference in an upper boundary of a decorative pattern thereon. As with sleeve 10e, sleeve 10j has an upper portion 12j, a lower portion 14j, and a detaching element 24j therebetween. The sleeve 10j further comprises an upper end 16j, a lower end 18j, a decorative pattern 26j on the lower portion 14j, an upper boundary 28j in the decorative pattern 26j and a clear zone 30j between the detaching element 24j and the upper boundary 28j. The upper boundary 28j, when the sleeve is in a flattened condition, has an arcuate shape. The sleeve 10j may optionally further have a gusset 38j therein. The upper boundary 28j of the decorative pattern 26j is configured on the lower portion 14j such that when the sleeve 10j is in the open position (for example when disposed about the pot 40), the upper boundary 28j of the decorative pattern 26j is disposed a substantially equivalent vertical distance 60j from a perimeter 21j of a bottom 19j of the opened sleeve 10j. That is, the upper boundary 28j is disposed in an imaginary plane 66 which is substantially parallel to a plane of the perimeter 21j of the bottom 19j as shown in FIG. 16, and substantially parallel to the upper rim 42 of the pot 40 and the plane 43 of the upper rim 42 (FIG. 3) when the pot 40 is disposed therein as in FIGS. 16 and 17.

When the upper portion 12j is removed from the lower portion 14j by detaching along the detaching element 24j, the lower portion 14j is left with an upper edge 48j which is disposed a distance above the upper rim 42 of the pot 40 (FIG. 17). The lower portion 14j is given the illusion of having an upper edge which corresponds to the upper rim 42 of the pot 40 due to the conspicuousness of the upper boundary 28j of the decorative pattern 26j and the relative transparency, and thus invisibility, of the clear zone 30j.

Shown in FIG. 18 is an alternative embodiment of the present invention. Sleeve 10k is basically the same as sleeve 10j, except for the size of an upper portion 12k. The upper portion 12k is detachable from the lower portion 14k which includes thereon a decorative pattern 26k which has an upper boundary 28k having an arcuate shape in the flattened condition. A detaching element 24k is disposed between the upper portion 12k and the lower portion 14k. As with sleeve 10j, the portion of the lower portion 14k disposed between the detaching element 24k and the upper boundary 28k of the decorative pattern 26k is a clear zone 30k. The sleeve 10k has an upper end 16k and a lower end 18k and may optionally comprise a gusset therein. Unlike the upper portion 12j of sleeve 10j, the upper portion 12k of sleeve 10k is not sized to substantially surround and enclose a floral grouping. Rather, the primary function of the upper portion 12k is to support the sleeve 10k from a support device, such as a wicket (not shown), wherein a plurality of sleeves 10k can be supported together in the same manner as a plurality of sleeves 10j can be supported. When the upper portion 12k is separated from the lower portion 14k via the detaching element 24k, and the lower portion 14k is disposed about a pot, the decorative cover formed from the lower portion 14k appears substantially the same as the embodiment of sleeve 10j shown in FIG. 17 after the upper portion 12j has been detached.

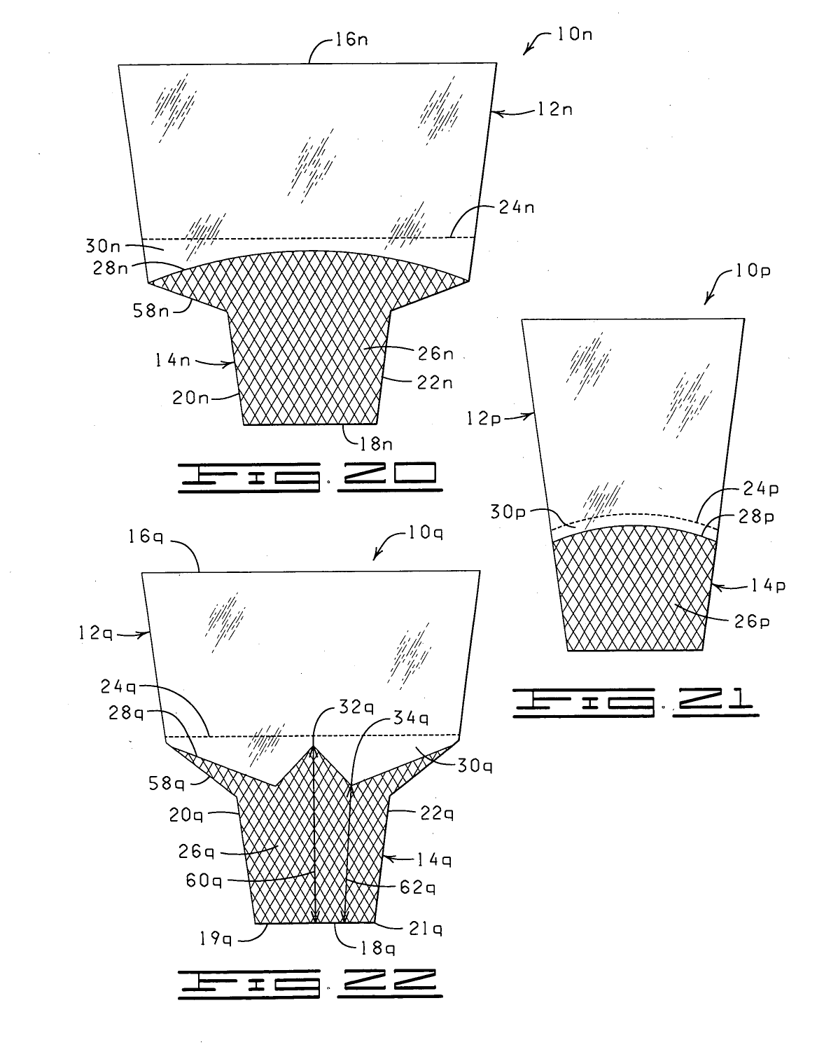

Shown in FIG. 19 is an alternative embodiment of the present invention. Sleeve 10m is substantially the same as sleeve 10j except sleeve 10m does not include an upper portion detachable from the lower portion 14m. Sleeve 10m includes a decorative pattern 26m having an upper boundary 28m having an arcuate shape in the flattened condition. The sleeve 10m has a clear zone 30m between the upper boundary 28m of the decorative pattern 26m and an upper edge 48m of the sleeve 10m. When opened and placed about a pot, sleeve 10m appears substantially the same as the embodiment of sleeve 10j shown in FIG. 17 after the upper portion 12j has been detached.

Shown in FIG. 20 is a sleeve 10n which is substantially the same as sleeve 10j, comprising an upper portion 12n, a lower portion 14n, an upper end 16n, a lower end 18n, a substantially horizontal detaching element 24n between the upper portion 12n and the lower portion 14n, a decorative pattern 26n having an upper boundary 28n having an arcuate shape in the flattened condition, and a clear zone 30n between the detaching element 24n and the upper boundary 28n of the decorative pattern 26n. In particular, sleeve 10n differs from sleeve 10j by having an outwardly-extending skirt portion 58n which extends away from tapered first and second sides 20n and 22n of the lower portion 14n such that when the upper portion 12n is detached from the lower portion 14n and a pot is disposed in the lower portion 14n, the skirt portion 58n extends at an angle away from the lower portion 14n.

Shown in FIG. 21 is a sleeve 10p which is similar to the sleeve 10j shown in FIG. 15 wherein the sleeve 10p has a decorative pattern 26p having an upper boundary 28p having an arcuate shape in the flattened condition, and has a detaching element 24p disposed between an upper portion 12p and a lower portion 14p, and has a clear zone 30p between the upper boundary 28p of the decorative pattern 26p and the detaching element 24p. Sleeve 10p differs from sleeve 10j primarily in that the detaching element 24p has a pattern which generally corresponds to the arcuate curvature of the upper boundary 28p of the decorative pattern 26p. The clear zone 30p may alternatively be negligible or non-existent.

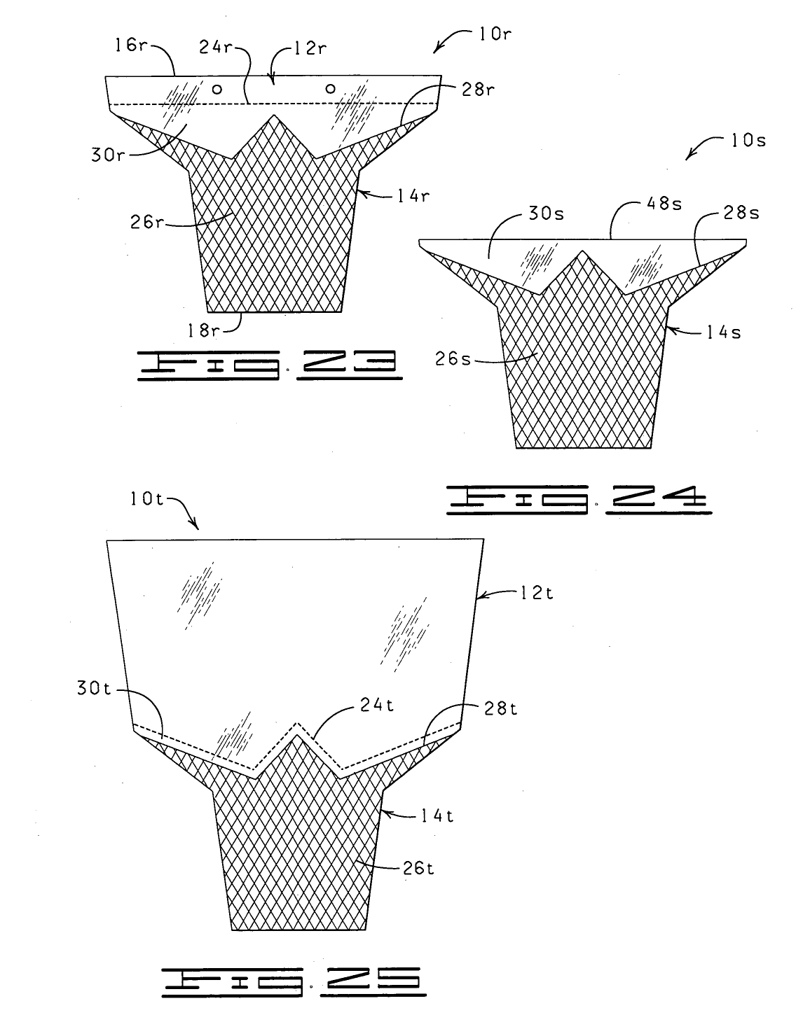

FIGS. 22-25

Shown in FIG. 22 is a sleeve 10q which is similar to the sleeve 10c shown in FIG. 6 except for a difference in the position of the non-linear upper boundary of a decorative pattern thereon. As with sleeve 10c, sleeve 10q has an upper portion 12q, a lower portion 14q, and a detaching element 24q therebetween. The sleeve 10q further comprises an upper end 16q, a lower end 18q, a decorative pattern 26q on the lower portion 14q, a non-linear upper boundary 28q, having an angular shape, in the decorative pattern 26q and a clear zone 30q between the detaching element 24q and the non-linear upper boundary 28q. The sleeve 10q also has an inner peripheral surface (not shown) which, when the sleeve 10 is opened, defines and encompasses an inner retaining space as indicated in FIGS. 2 and 3. The sleeve 10q may optionally further have a gusset therein. The non-linear upper boundary 28q of the decorative pattern 26q is configured on the lower portion 14q such that when the sleeve 10q is in the open position (for example when disposed about a pot), each peak 32q of the non-linear upper boundary 28q is disposed a substantially equal peak vertical distance 60q from a perimeter 21q of a bottom 19q of the opened sleeve 10q and each trough 34q of the non-linear upper boundary 28q is disposed a substantially equal trough vertical distance 62q from the perimeter 21q of the bottom 19q of the opened sleeve 10q in a manner similar to that shown for sleeve 10e in FIG. 9.

When the upper portion 12q is removed from the lower portion 14q by detaching along the detaching element 24q, the lower portion 14q is left with an upper end which is disposed a distance above an upper rim of a pot. Although the remaining upper end is generally straight, the lower portion 14q is given the illusion of having an angular upper edge due to the conspicuousness of the non-linear upper boundary 28q of the decorative pattern 26q and the relative transparency, and thus invisibility, of the clear zone 30q.

Sleeve 10q further comprises an outwardly-extending skirt portion 58q which extends away from tapered first and second sides 20q and 22q of the lower portion 14q such that when the upper portion 12q is detached from the lower portion 14q and a pot is disposed in the lower portion 14q, the skirt portion 58q extends at an angle away from the lower portion 14q.

Shown in FIG. 23 is an alternative embodiment of the present invention. Sleeve 10r is basically the same as sleeve 10q, except for the size of an upper portion 12r. The upper portion 12r is detachable from a lower portion 14r which has a decorative pattern 26r which has a non-linear upper boundary 28r having an angular shape. A detaching element 24r is disposed between the upper portion 12r and the lower portion 14r. As with sleeve 10q, a clear zone 30r of the lower portion 14r is disposed between the non-linear upper boundary 28r of the decorative pattern 26r and an upper end 16r of the sleeve 10r. The sleeve 10r has a lower end 18r and may optionally include a gusset therein. Unlike the upper portion 12q of sleeve 10q, the upper portion 12r of sleeve 10r is not sized to substantially surround and encompass a floral grouping. Rather, the primary function of the upper portion 12r is to support the sleeve 10r from a support device, such as a wicket (not shown), wherein a plurality of sleeves 10r can be supported together in the same manner as a plurality of sleeves 10q can be supported. When the upper portion 12r is separated from the lower portion 14r via the detaching element 24r, and the lower portion 14r is disposed about a pot, the decorative cover formed from the lower portion 14r appears substantially the same as the embodiment of sleeve 10q after the upper portion 12q is removed.

Shown in FIG. 24 is an alternative embodiment of the present invention. Sleeve 10s is basically the same as sleeve 10q except sleeve 10s does not include an upper portion detachable from a lower portion 14s. Sleeve 10s includes a decorative pattern 26s having a non-linear upper boundary 28s having an angular shape. The sleeve 10s has a clear zone 30s between the non-linear upper boundary 28s of the decorative pattern 26s and an upper edge 48s of the sleeve 10s. When opened and placed about a pot, sleeve 10s appears substantially the same as the embodiment of sleeve 10q after the upper portion 12q is removed therefrom.

Shown in FIG. 25 is a sleeve 10t which is basically the same as sleeve 10q shown in FIG. 22 wherein the sleeve 10t has a decorative pattern 26t having a non-linear upper boundary 28t having an angular shape, and has a detaching element 24t disposed between an upper portion 12t and a lower portion 14t, and has a clear zone 30t between the non-linear upper boundary 28t of the decorative pattern 26t and the detaching element 24t. Sleeve 10t differs from sleeve 10q primarily in that the detaching element 24t has a pattern which generally corresponds to the angular curvature of the non-linear upper boundary 28t of the decorative pattern 26t. The clear zone 30t may be negligible or non-existent.

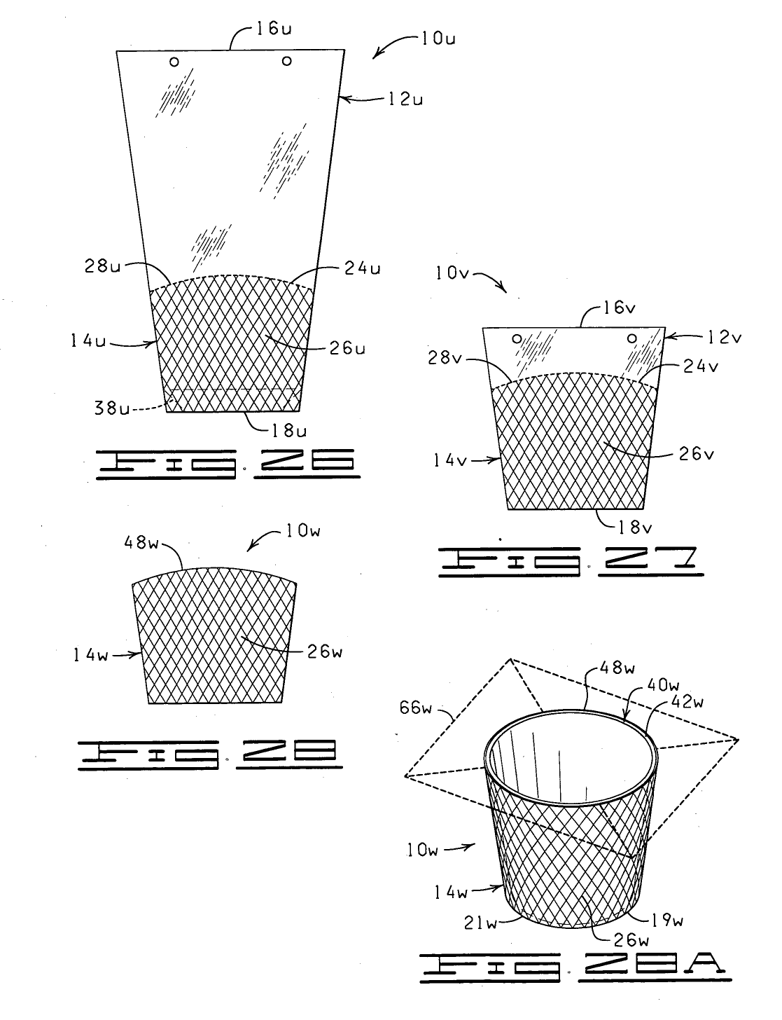

FIGS. 26-29

Shown in FIG. 26 is a sleeve 10u which is substantially the same as sleeve 10j (FIG. 15) except for a difference in the relation of a non-linear upper boundary of a decorative pattern thereon and a detaching element therein. As with sleeve 10j, sleeve 10u has an upper portion 12u, a lower portion 14u, and a detaching element 24u therebetween. The sleeve 10u further includes an upper end 16u, a lower end 18u, a decorative pattern 26u on the lower portion 14u, and an upper boundary 28u in the decorative pattern 26u which has an arcuate shape in the flattened condition. The sleeve 10u may optionally further have a gusset 38u therein. The upper boundary 28u of the decorative pattern 26u is configured to coincide with the detaching element 24u. When the upper portion 12u is removed from the lower portion 14u, the upper boundary 28u of the decorative pattern 26u comprises an upper end of the remaining lower portion 14u of the sleeve 10u. Sleeve 10u is the same as sleeve 10p in FIG. 21 when there is no clear zone 30r in sleeve 10p.

Shown in FIG. 27 is an alternative embodiment of the present invention. Sleeve 10v is basically the same as sleeve 10u, except for the size of an upper portion 12v. The upper portion 12v is detachable from a lower portion 14v which includes thereon a decorative pattern 26v which has an upper boundary 28v having an arcuate shape in the flattened condition. A detaching element 24v is disposed between the upper portion 12v and the lower portion 14v. As with sleeve 10u, the upper boundary 28v of the decorative pattern 26v coincides with the detaching element 24v. The sleeve 10v has an upper end 16v and a lower end 18v and may optionally comprise a gusset therein. Unlike the upper portion 12u of sleeve 10u, the upper portion 12v of sleeve 10v is not sized to substantially surround and enclose a floral grouping. Rather, the primary function of the upper portion 12v is to support the sleeve 10v from a support device, such as a wicket (not shown), wherein a plurality of sleeves 10v can be supported together in the same manner as a plurality of sleeves 10u can be supported. When the upper portion 12v is separated from the lower portion 14v via the detaching element 24v, the decorative cover formed from the lower portion 14v appears substantially the same as lower portion 14u of sleeve 10u when the upper portion 12q is detached therefrom.

Shown in FIGS. 28 and 28A is an alternative embodiment of the present invention. Sleeve 10w is substantially the same as sleeve 10u except sleeve 10w comprises only a lower portion 14w, not an upper portion detachable from the lower portion 14w. Sleeve 10w includes a decorative pattern 26w having an upper edge 48w having an arcuate shape and disposed in a single plane 66w as shown schematically in FIG. 28A. When opened and placed about a pot, sleeve 10w appears substantially the same as the embodiment of sleeve 10u after the upper portion 12u is removed and the remaining lower portion 14u is disposed about a pot. The plane 66w of the upper edge 48w is substantially parallel to the upper rim 42 of the pot 40 and to the perimeter 21w of the bottom 19w of the lower portion 14w.

Shown in FIG. 29 is a sleeve 10x which is substantially the same as sleeve 10u, comprising an upper portion 12x, a lower portion 14x, an upper end 16x, a lower end 18x, and a detaching element 24x which coincides with an upper boundary 28x of a decorative pattern 26x, the upper boundary 28x having an arcuate shape when flat. Sleeve 10x differs from sleeve 10u by having an outwardly-extending skirt portion 58x which extends away from tapered first and second sides 20x and 22x of the lower portion 14x such that when the upper portion 12x is detached from the lower portion 14x and a pot is disposed in the lower portion 14x, the skirt portion 58x extends at an angle away from the lower portion 14x.

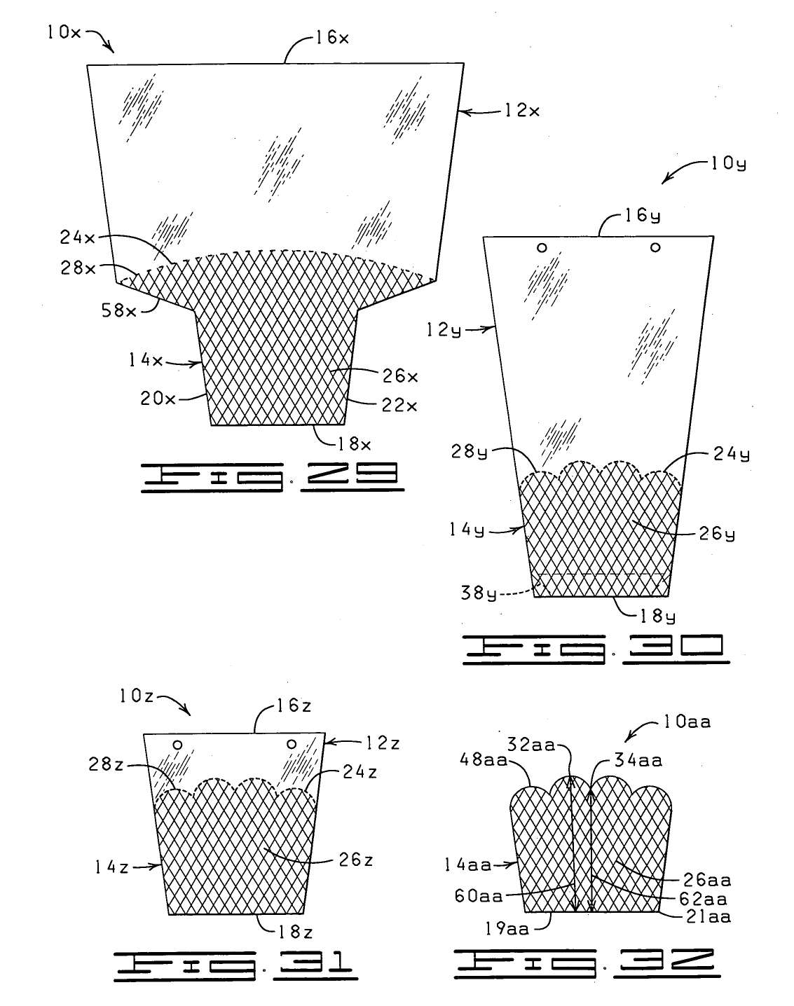

FIGS. 30-33

Shown in FIG. 30 is a sleeve 10y which is substantially the same as sleeve 10e in FIG. 8 except for a difference in the position of a detaching element 24y. As with sleeve 10e, sleeve 10y has an upper portion 12y, a lower portion 14y, and the detaching element 24y therebetween. The sleeve 10y further includes an upper end 16y, a lower end 18y, a decorative pattern 26y on the lower portion 14y, and a non-linear upper boundary 28y in the decorative pattern 26y. The non-linear upper boundary 28y of the decorative pattern 26y is configured to coincide with the detaching element 24y. When the upper portion 12y is removed from the lower end 14y, the non-linear upper boundary 28y of the decorative pattern 26y comprises an upper edge of the remaining lower portion 14y of the sleeve 10y. The sleeve 10e may optionally further have a gusset 38y therein. Sleeve 10y is the same as sleeve 10i, FIG. 14, when there is no clear zone 30i in sleeve 10i.

Shown in FIG. 31 is an alternative embodiment of the present invention. Sleeve 10z is essentially the same as-sleeve 10y, except for-the size of an upper portion 12z. The upper portion 12z is detachable from a lower portion 14z which includes thereon a decorative pattern 26z which has a non-linear upper boundary 28z. A detaching element 24z is disposed between the upper portion 12z and the lower portion 14z and coincides with the non-linear upper boundary 28z. The sleeve 10z has an upper end 16z and a lower end 18z and may optionally comprise a gusset therein. Unlike the upper portion 12y of sleeve 10y, the upper portion 12z of sleeve 10z is not sized to substantially surround and encompass a floral grouping. Rather, the primary function of the upper portion 12z is to support the sleeve 10z from a support device, such as a wicket (not shown), wherein a plurality of sleeves 10z can be supported together in the same manner as a plurality of sleeves 10y can be supported. When the upper portion 12z is separated from the lower portion 14z via the detaching element 24z, and the lower portion 14z is disposed about a pot, the decorative cover formed from the lower portion 14z appears substantially the same as the embodiment of sleeve 10y after the upper portion 12y has been removed therefrom.

Shown in FIG. 32 is an alternative embodiment of the present invention. Sleeve 10aa is basically the same as sleeve 10y except sleeve 10aa does not include an upper portion detachable from a lower portion 14aa. Sleeve 10aa includes a decorative pattern 26aa having a non-linear upper edge 48aa. When opened and placed about a pot, sleeve 10aa appears substantially the same as the embodiment of sleeve 10y or sleeve 10z after the upper portion 12y or 12z has been removed and the remaining lower portion 14y or 14z has been disposed about a pot. That is, the upper edge 48aa of the sleeve 10aa is configured such that When the sleeve 10aa is in the open position (for example when disposed about a pot), each peak 32aa of the upper edge 48aa is disposed about a substantially equal peak vertical distance 60aa from a perimeter 21aa of a bottom 19aa of the opened sleeve 10aa and each trough 34aa of the upper edge 48aa is disposed about a substantially equal trough vertical distance 62aa from the perimeter 21aa of the bottom 19aa of the opened sleeve 10aa, in a manner similar to sleeve 10e shown in FIG. 10.

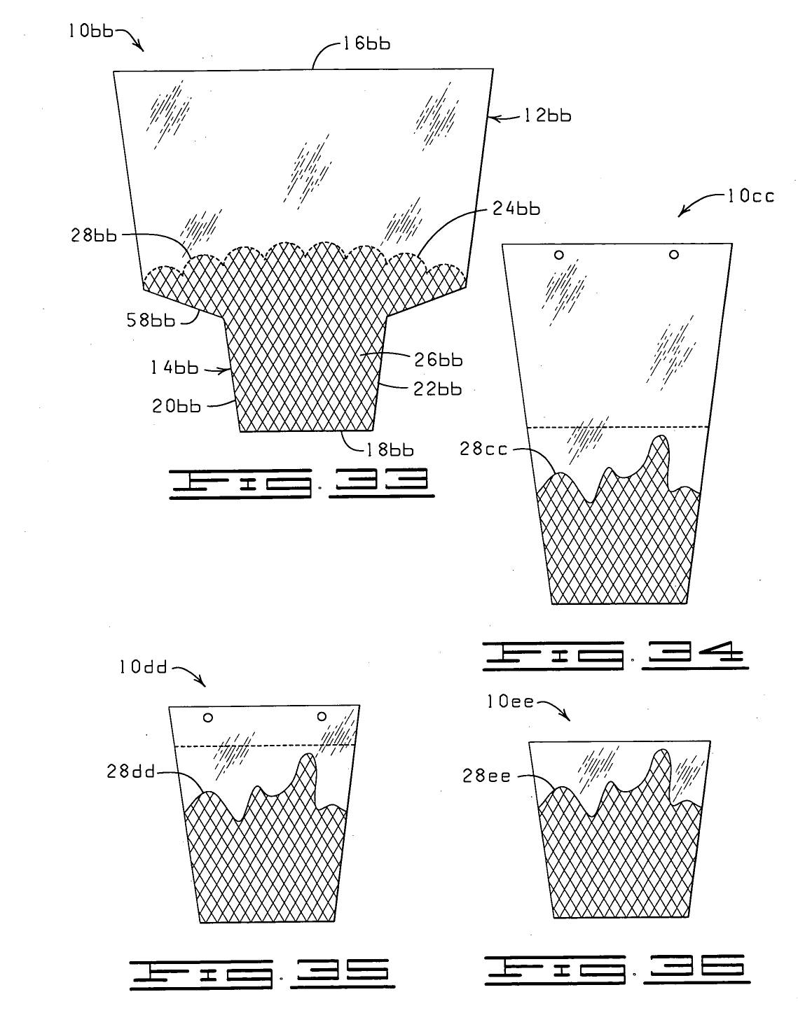

Shown in FIG. 33 is a sleeve 10bb which is substantially the same as sleeve 10y, comprising an upper portion 12bb, a lower portion 14bb, an upper end 16bb, a lower end 18bb and a non-linear detaching element 24bb which correspond to a non-linear upper boundary 28bb of a decorative pattern 26bb. Sleeve 10bb differs from sleeve 10y by having an outwardly-extending skirt portion 58bb which extends away from tapered first and second sides 20bb. and 22bb of the lower portion 14bb such that when the upper portion 12bb is detached from the lower portion 14bb and a pot is disposed in the lower portion 14bb, the skirt portion 58bb extends at an angle away from the lower end 14bb.

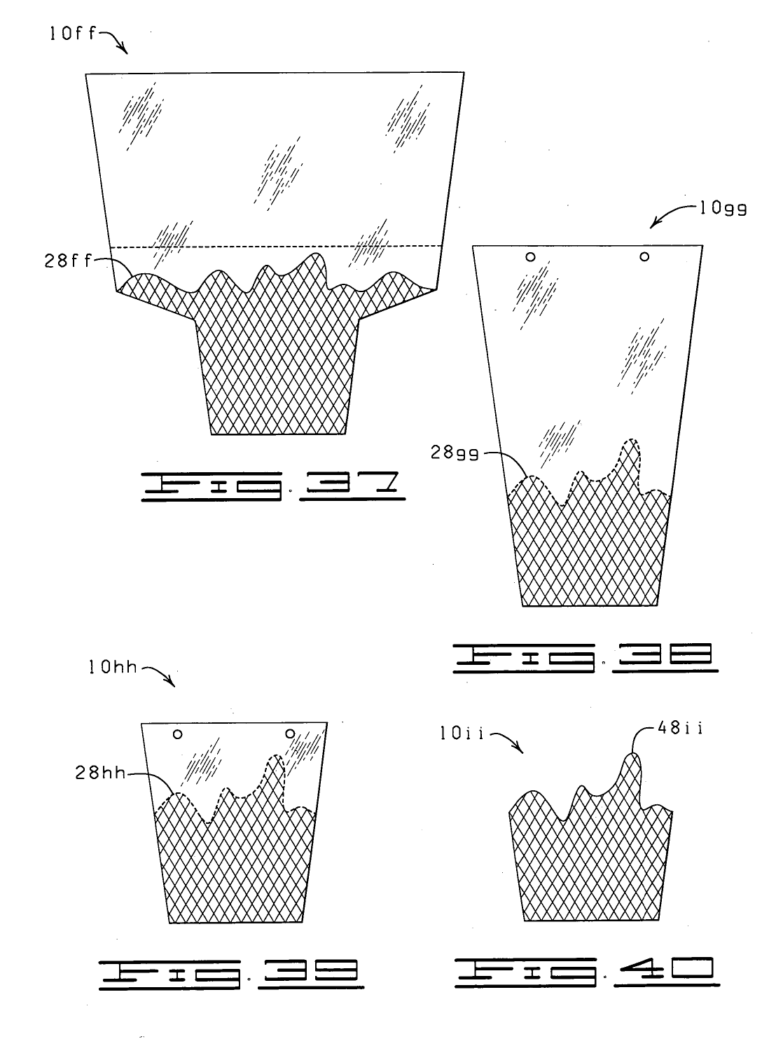

FIGS. 34-40

Shown in FIGS. 34-37 are sleeves 10cc, 10dd, 10ee and 10ff which are essentially the same as sleeves 10, 10a, 10b, and 10c, respectively, except non-linear upper boundaries 28cc, 28dd, 28ee, and 28ff of the sleeves 10cc, 10dd, 10ee and 10ff are irregular, for example, having random peaks and dips.

Likewise, sleeves 10gg, 10hh, and 10ii, of FIGS. 38-40, respectively, are similar to sleeves 10y, 10z, and 10aa of FIGS. 30-32, respectively, except non-linear upper boundaries 28gg, 28hh, and 48ii of the sleeves 10gg, 10hh and 10ii, are irregular, for example having random peaks and dips.

It will also be understood that any of the sleeves 10-10ii described herein can be used to contain a floral grouping and a growing medium without a pot, wherein the floral grouping is cultivated in the sleeves 10-10ii, or placed with a growing medium in the sleeves 10-10ii in a substantially grown condition.

Changes may be made in the construction and the operation of the various components, elements and assemblies described herein or in the steps or the sequence of steps of the methods described herein without departing from the spirit-and scope-of the invention as defined in the following claims.

1. A package for containing at least one of a floral grouping, flower pot, botanical item, propagule and growing medium, the package comprising:
a sleeve having a flattened condition and having a decorative pattern or color which has an upper boundary wherein at least a portion of the upper boundary is below an upper edge of the sleeve, wherein the upper boundary of the decorative pattern or color has a configuration and the upper edge of the sleeve has a configuration different from the configuration of the upper boundary of the decorative pattern or color such that the upper edge of the sleeve has the appearance of having the configuration of the upper boundary of the decorative pattern or color.

2. The package of claim 1 wherein the configuration of the upper boundary of the decorative pattern or color is selected from the group consisting of linear, non-linear, arcuate and combinations thereof.

3. The package of claim 1 wherein the configuration of the upper edge of the sleeve is selected from the group consisting of linear, non-linear, arcuate and combinations thereof.

4. The package of claim 1 wherein the upper boundary of the decorative pattern or color is provided with a non-linear configuration and wherein the upper edge of the sleeve is provided with a linear configuration, whereby the sleeve is provided with an appearance of having a non-linear upper edge.

5. The package of claim 1 wherein the sleeve is adapted to be suspended from a support element.

6. The package of claim 1 wherein the upper boundary of the decorative pattern or color comprises a plurality of peaks and troughs wherein the peaks are generally within 0 mm to about 25 mm of the upper edge of the sleeve and the troughs are generally about 10 mm to about 60 mm below the upper edge of the sleeve.

7. The package of claim 1 wherein a lower end of the sleeve is open.

8. The package of claim 1 wherein a lower end of the sleeve is closed.

9. The package of claim 8 wherein the lower end of the sleeve has a gusset therein.

10. The package of claim 8 wherein the sleeve is provided with a drain hole.

11. The package of claim 1 wherein the sleeve is formed of a liquid impermeable material.

12. The package of claim 1 wherein the sleeve initially has a flattened state.

13. The package of claim 1 wherein the sleeve is further defined as comprising a base portion and a skirt portion extending from at least a portion of the base portion.

14. The package of claim 1 wherein a clear zone is provided between the upper boundary of the decorative pattern or color and the upper edge of the sleeve.

15. A package for containing at least one of a floral grouping, flower pot, botanical item, propagule and growing medium, the package comprising:
a sleeve having a flattened condition and comprising:
a lower portion;
an upper portion extending from at least a portion of the lower portion and being detachable therefrom via a detaching element, wherein the detaching element defines an upper edge of the lower portion of the sleeve; and
a decorative pattern or color having an upper boundary wherein at least a portion of the upper boundary is below the upper edge of the lower portion of the sleeve, wherein the upper boundary of the decorative pattern or color has a configuration and the upper edge of the lower portion has a configuration different from the configuration of the upper boundary of the decorative pattern or color such that when the upper portion of the sleeve is removed, the upper edge of the lower portion of the sleeve has the appearance of having the configuration of the upper boundary of the decorative pattern or color.

16. The package of claim 15 wherein the configuration of the upper boundary of the decorative pattern or color is selected from the group consisting of linear, non-linear, arcuate and combinations thereof.

17. The package of claim 15 wherein the configuration of the upper edge of the lower portion of the sleeve is selected from the group consisting of linear, non-linear, arcuate and combinations thereof.

18. The package of claim 15 wherein the upper boundary of the decorative pattern or color is provided with a non-linear configuration and wherein the upper edge of the lower portion of the sleeve is provided with a linear configuration, whereby when the upper portion of the sleeve is removed, the lower portion of the sleeve is provided with an appearance of having a non-linear upper edge.

19. The package of claim 15 wherein the sleeve is adapted to be suspended from a support element.

20. The package of claim 15 wherein the upper boundary of the decorative pattern or color comprises a plurality of peaks and troughs wherein the peaks are generally within 0 mm to about 25 mm of the upper edge of the lower portion of the sleeve and the troughs are generally about 10 mm to about 60 mm below the upper edge of the lower portion of the sleeve.

21. The package of claim 15 wherein a lower end of the sleeve is open.

22. The package of claim 15 wherein a lower end of the sleeve is closed.

23. The package of claim 22 wherein the lower end of the sleeve has a gusset therein.

24. The package of claim 22 wherein the sleeve is provided with a drain hole.

25. The package of claim 15 wherein the sleeve is formed of a liquid impermeable material.

26. The package of claim 15 wherein the sleeve initially has a flattened state.

27. The package of claim 15 wherein the lower portion of the sleeve is further defined as comprising a base portion and a skirt portion extending from at least a portion of the base portion.

28. The package of claim 27 wherein the upper portion extends from at least a portion of the skirt portion of the lower portion of the sleeve.

29. The package of claim 27 wherein the upper portion extends from at least a portion of the base portion of the lower portion of the sleeve.

30. The package of claim 15 wherein the upper portion is sized to substantially surround at least a portion of a floral grouping disposed within a flower pot disposed in the sleeve.

31. The package of claim 15 wherein a clear zone is provided between the upper boundary of the decorative pattern or color and the upper edge of the lower portion of the sleeve.

32. A method for providing a package for at least one of a floral grouping, flower pot, botanical item, propagule and growing medium, the method comprising the steps of:
providing a sleeve having a flattened condition and having a decorative pattern or color which has an upper boundary wherein at least a portion of the upper boundary is below an upper edge of the sleeve, wherein the upper boundary of the decorative pattern or color has a configuration and the upper edge of the sleeve has a configuration different from the configuration of the upper boundary of the decorative pattern or color such that the upper edge of the sleeve has the appearance of having the configuration of the upper boundary of the decorative pattern or color; and
disposing at least one of a floral grouping, flower pot, botanical item, propagule and growing medium in the sleeve.

33. The method of claim 32 wherein, in the step of providing a sleeve, the configuration of the upper boundary of the decorative pattern or color is selected from the group consisting of linear, non-linear, arcuate and combinations thereof.

34. The method of claim 32 wherein, in the step of providing a sleeve, the configuration of the upper edge of the sleeve is selected from the group consisting of linear, non-linear, arcuate and combinations thereof.

35. The method of claim 32 wherein, in the step of providing a sleeve, the upper boundary of the decorative pattern or color is provided with a non-linear configuration and wherein the upper edge of the sleeve is provided with a linear configuration, whereby the sleeve is provided with an appearance of having a non-linear upper edge.

36. The method of claim 32 wherein, in the step of providing a sleeve, the sleeve is adapted to be suspended from a support element.

37. The method of claim 32 wherein, in the step of providing a sleeve, the upper boundary of the decorative pattern or color comprises a plurality of peaks and troughs wherein the peaks are generally within 0 mm to about 25 mm of the upper edge of the sleeve and the troughs are generally about 10 mm to about 60 mm below the upper edge of the sleeve.

38. The method of claim 32 wherein, in the step of providing a sleeve, a lower end of the sleeve is open.

39. The method of claim 32 wherein, in the step of providing a sleeve, a lower end of the sleeve is closed.

40. The method of claim 39 wherein the lower end of the sleeve has a gusset therein.

41. The method of claim 39 wherein the sleeve is provided with a drain hole.

42. The method of claim 32 wherein, in the step of providing a sleeve, the sleeve is formed of a liquid impermeable material.

43. The method of claim 32 wherein the sleeve initially has a flattened state.

44. The method of claim 32 wherein, in the step of providing a sleeve, the sleeve is further defined as comprising a base portion and a skirt portion extending from at least a portion of the base portion.

45. The method of claim 32 wherein, in the step of providing a sleeve, a clear zone is provided in between the upper boundary of the decorative pattern or color and the upper edge of the sleeve.

46. A method for providing a package for at least one of a floral grouping, flower pot, botanical item, propagule and growing medium, the method comprising the steps of:
providing a sleeve having a flattened condition and comprising:
a lower portion;
an upper portion extending from at least a portion of the lower portion and being detachable therefrom via a detaching element, wherein the detaching element defines an upper edge of the lower portion of the sleeve; and
a decorative pattern or color having an upper boundary wherein at least a portion of the upper boundary is below the upper edge of the lower portion of the sleeve, wherein the upper boundary of the decorative pattern or color has a configuration and the upper edge of the lower portion has a configuration different from the configuration of the upper boundary of the decorative pattern or color such that when the upper portion of the sleeve is removed, the upper edge of the lower portion of the sleeve has the appearance of having the configuration of the upper boundary of the decorative pattern or color; and
disposing at least one of a floral grouping, flower pot, botanical item, propagule and growing medium in the sleeve.

47. The method of claim 46 wherein, in the step of providing a sleeve, the configuration of the upper boundary of the decorative pattern or color is selected from the group consisting of linear, non-linear, arcuate and combinations thereof.

48. The method of claim 46 wherein, in the step of providing a sleeve, the configuration of the upper edge of the lower portion of the sleeve is selected from the group consisting of linear, non-linear, arcuate and combinations thereof.

49. The method of claim 46 wherein, in the step of providing a sleeve, the upper boundary of the decorative pattern or color is provided with a non-linear configuration and wherein the upper edge of the lower portion of the sleeve is provided with a linear configuration, whereby when the upper portion of the sleeve is removed, the lower portion of the sleeve is provided with an appearance of having a non-linear upper edge.

50. The method of claim 46 wherein, in the step of providing a sleeve, the sleeve is adapted to be suspended from a support element.

51. The method of claim 46 wherein, in the step of providing a sleeve, the upper boundary of the decorative pattern or color comprises a plurality of peaks and troughs wherein the peaks are generally within 0 mm to about 25 mm of the upper edge of the lower portion of the sleeve and the troughs are generally about 10 mm to about 60 mm below the upper edge of the lower portion of the sleeve.

52. The method of claim 46 wherein, in the step of providing a sleeve, a lower end of the sleeve is open.

53. The method of claim 46 wherein, in the step of providing a sleeve, a lower end of the sleeve is closed.

54. The method of claim 53 wherein the lower end of the sleeve has a gusset therein.

55. The method of claim 53 wherein the sleeve is provided with a drain hole.

56. The method of claim 46 wherein, in the step of providing a sleeve, the sleeve is formed of a liquid impermeable material.

57. The method of claim 46 wherein, in the step of providing a sleeve, the sleeve initially has a flattened state.

58. The method of claim 46 wherein, in the step of providing a sleeve, the lower portion of the sleeve is further defined as comprising a base portion and a skirt portion extending from at least a portion of the base portion.

59. The method of claim 58 wherein the upper portion extends from at least a portion of the skirt portion of the lower portion of the sleeve.

60. The method of claim 58 wherein the upper portion extends from at least a portion of the base portion of the lower portion of the sleeve.

61. The method of claim 46 wherein, in the step of providing a sleeves the upper portion is sized to substantially surround at least a portion of a floral grouping disposed within a flower pot disposed in the sleeve.

62. The method of claim 46 further comprising the step of detaching the upper portion of the sleeve from the lower portion of the sleeve along the detaching element after disposing at least one of a floral grouping, flower pot, botanical item, propagule and growing medium in the sleeve, wherein the upper edge of the lower portion of the sleeve is provided With the appearance of having the configuration of the upper boundary of the decorative pattern or color.

63. The method of claim 46 further comprising the step of detaching the upper portion of the sleeve from the lower portion of the sleeve along the detaching element before disposing at least one of a floral grouping, flower pot, botanical item, propagule and growing medium in the sleeve, wherein the upper edge of the lower portion of the sleeve is provided with the appearance of having the configuration of the upper boundary of the decorative pattern or color.

64. The method of claim 46 wherein, in the step of providing a sleeve, a clear zone is provided between the upper boundary of the decorative pattern or color and the upper edge of the lower portion of the sleeve.

65. A package for containing at least one of a floral grouping, flower pot, botanical item, propagule and growing medium, the package comprising:
a sleeve having a flattened condition and having a decorative pattern or color which has an upper boundary wherein at least a portion of the upper boundary is below an upper edge of the sleeve, wherein the upper boundary of the decorative pattern or color has a configuration and the upper edge of the sleeve has a configuration different from the configuration of the upper boundary of the decorative pattern or color.

66. The package of claim 65 wherein the configuration of the upper boundary of the decorative pattern or color is selected from the group consisting of linear, non-linear, arcuate and combinations thereof.

67. The package of claim 65 wherein the configuration of the upper edge of the sleeve is selected from the group consisting of linear, non-linear, arcuate and combinations thereof.

68. The package of claim 65 wherein the upper boundary of the decorative pattern or color is provided with a non-linear configuration and wherein the upper edge of the sleeve is provided with a linear configuration, whereby the sleeve is provided with an appearance of having a non-linear upper edge.

69. The package of claim 65 wherein the sleeve is adapted to be suspended from a support element.

70. The package of claim 65 wherein the upper boundary of the decorative pattern or color comprises a plurality of peaks and troughs wherein the peaks are generally within 0 mm to about 25 mm of the upper edge of the sleeve and the troughs are generally about 10 mm to about 60 mm below the upper edge of the sleeve.

71. The package of claim 65 wherein a lower end of the sleeve is open.

72. The package of claim 65 wherein a lower end of the sleeve is closed.

73. The package of claim 72 wherein the lower end of the sleeve has a gusset therein.

74. The package of claim 72 wherein the sleeve is provided with a drain hole.

75. The package of claim 65 wherein the sleeve is formed of a liquid impermeable material.

76. The package of claim 65 wherein the sleeve initially has a flattened state.

77. The package of claim 65 wherein the sleeve is further defined as comprising a base portion and a skirt portion extending from at least a portion of the base portion.

78. The package of claim 65 wherein a clear zone is provided between the upper boundary of the decorative pattern or color and the upper edge of the sleeve.

79. A package for containing at least one of a floral grouping, flower pot, botanical item, propagule and growing medium, the package comprising:
a sleeve having a flattened condition and comprising:
a lower portion;
an upper portion extending from at least a portion of the lower portion and being detachable therefrom via a detaching element, wherein the detaching element defines an upper edge of the lower portion of the sleeve; and
a decorative pattern or color having an upper boundary wherein at least a portion of the upper boundary is below the upper edge of the lower portion of the sleeve, wherein the upper boundary of the decorative pattern or color has a configuration and the upper edge of the lower portion has a configuration different from the configuration of the upper boundary of the decorative pattern or color.

80. The package of claim 79 wherein the configuration of the upper boundary of the decorative pattern or color is selected from the group consisting of linear, non-linear, arcuate and combinations thereof.

81. The package of claim 79 wherein the configuration of the upper edge of the lower portion of the sleeve is selected from the group consisting of linear, non-linear, arcuate and combinations thereof.

82. The package of claim 79 wherein the upper boundary of the decorative pattern or color is provided with a non-linear configuration and wherein the upper edge of the lower portion of the sleeve is provided with a linear configuration, whereby when the upper portion of the sleeve is removed, the lower portion of the sleeve is provided with an appearance of having a non-linear upper edge.

83. The package of claim 79 wherein the sleeve is adapted to be suspended from a support element.

84. The package of claim 79 wherein the upper boundary of the decorative pattern or color comprises a plurality of peaks and troughs wherein the peaks are generally within 0 mm to about 25 mm of the upper edge of the lower portion of the sleeve and the troughs are generally about 10 mm to about 60 mm below the upper edge of the lower portion of the sleeve.

85. The package of claim 79 wherein a lower end of the sleeve is open.

86. The package of claim 79 wherein a lower end of the sleeve is closed.

87. The package of claim 86 wherein the lower end of the sleeve has a gusset therein.

88. The package of claim 86 wherein the sleeve is provided with a drain hole.

89. The package of claim 79 wherein the sleeve is formed of a liquid impermeable material.

90. The package of claim 79 wherein the sleeve initially has a flattened state.

91. The package of claim 79 wherein the lower portion of the sleeve is further defined as comprising a base portion and a skirt portion extending from at least a portion of the base portion.

92. The package of claim 91 wherein the upper portion extends from at least a portion of the skirt portion of the lower portion of the sleeve.

93. The package of claim 91 wherein the upper portion extends from at least a portion of the base portion of the lower portion of the sleeve.

94. The package of claim 79 wherein the upper portion is sized to substantially surround at least a portion of a floral grouping disposed within a flower pot disposed in the sleeve.

95. The package of claim 79 wherein a clear zone is provided between the upper boundary of the decorative pattern or color and the upper edge of the lower portion of the sleeve.

96. A method for providing a package for at least one of a floral grouping, flower pot, botanical item, propagule and growing medium, the method comprising the steps of:
providing a sleeve having a flattened condition and having a decorative pattern or color which has an upper boundary wherein at least a portion of the upper boundary is below an upper edge of the sleeve, wherein the upper boundary of the decorative pattern or color has a configuration and the upper edge of the sleeve has a configuration different from the configuration of the upper boundary of the decorative pattern or color; and
disposing at least one of a floral grouping, flower pot, botanical item, propagule and growing medium in the sleeve.

97. The method of claim 96 wherein, in the step of providing a sleeve, the configuration of the upper boundary of the decorative pattern or color is selected from the group consisting of linear, non-linear, arcuate and combinations thereof.

98. The method of claim 96 wherein, in the step of providing a sleeve, the configuration of the upper edge of the sleeve is selected from the group consisting of linear, non-linear, arcuate and combinations thereof.

99. The method of claim 96 wherein, in the step of providing a sleeve, the upper boundary of the decorative pattern or color is provided with a non-linear configuration and wherein the upper edge of the sleeve is provided with a linear configuration, whereby the sleeve is provided with an appearance of having a non-linear upper edge.

100. The method of claim 96 wherein, in the step of providing a sleeve, the sleeve is adapted to be suspended from a support element.

101. The method of claim 96 wherein, in the step of providing a sleeve, the upper boundary of the decorative pattern or color comprises a plurality of peaks and troughs wherein the peaks are generally within 0 mm to about 25 mm of the upper edge of the sleeve and the troughs are generally about 10 mm to about 60 mm below the upper edge of the sleeve.

102. The method of claim 96 wherein, in the step of providing a sleeve, a lower end of the sleeve is open.

103. The method of claim 96 wherein, in the step of providing a sleeve, a lower end of the sleeve is closed.

104. The method of claim 103 wherein the lower end of the sleeve has a gusset therein.

105. The method of claim 103 wherein the sleeve is provided with a drain hole.

106. The method of claim 96 wherein, in the step of providing a sleeve, the sleeve is formed of a liquid impermeable material.

107. The method of claim 96 wherein the sleeve initially has a flattened state.

108. The method of claim 96 wherein, in the step of providing a sleeve, the sleeve is further defined as comprising a base portion and a skirt portion extending from at least a portion of the base portion.

109. The method of claim 96 wherein, in the step of providing a sleeve, a clear zone is provided between the upper boundary of the decorative pattern or color and the upper edge of the sleeve.

110. A method for providing a package for at least one of a floral grouping, flower pot, botanical item, propagule and growing medium, the method comprising the steps of:
providing a sleeve having a flattened condition and comprising:
a lower portion;
an upper portion extending from at least a portion of the lower portion and being detachable therefrom via a detaching element, wherein the detaching element defines an upper edge of the lower portion of the sleeve; and
a decorative pattern or color having an upper boundary wherein at least a portion of the upper boundary is below the upper edge of the lower portion of the sleeve, wherein the upper boundary of the decorative pattern or color has a configuration and the upper edge of the lower portion has a configuration different from the configuration of the upper boundary of the decorative pattern or color; and
disposing at least one of a floral grouping, flower pot, botanical item, propagule and growing medium in the sleeve.

111. The method of claim 110 wherein, in the step of providing a sleeve, the configuration of the upper boundary of the decorative pattern or color is selected from the group consisting of linear, non-linear, arcuate and combinations thereof.

112. The method of claim 110 wherein, in the step of providing a sleeve, the configuration of the upper edge of the lower portion of the sleeve is selected from the group consisting of linear, non-linear, arcuate and combinations thereof.

113. The method of claim 110 wherein, in the step of providing a sleeve, the upper boundary of the decorative pattern or color is provided with a non-linear configuration and wherein the upper edge of the lower portion of the sleeve is provided with a linear configuration, whereby when the upper portion of the sleeve is removed, the lower portion of the sleeve is provided with an appearance of having a non-linear upper edge.

114. The method of claim 110 wherein, in the step of providing a sleeve, the sleeve is adapted to be suspended from a support element.

115. The method of claim 110 wherein, in the step of providing a sleeve, the upper boundary of the decorative pattern or color comprises a plurality of peaks and troughs wherein the peaks are generally within 0 mm to about 25 mm of the upper edge of the lower portion of the sleeve and the troughs are generally about 10 mm to about 60 mm below the upper edge of the lower portion of the sleeve.

116. The method of claim 110 wherein, in the step of providing a sleeve, a lower end of the sleeve is open.

117. The method of claim 110 wherein, in the step of providing a sleeve, a lower end of the sleeve is closed.

118. The method of claim 117 wherein the lower end of the sleeve has a gusset therein.

119. The method of claim 117 wherein the sleeve is provided with a drain hole.

120. The method of claim 110 wherein, in the step of providing a sleeve, the sleeve is formed of a liquid impermeable material.

121. The method of claim 110 wherein, in the step of providing a sleeve, the sleeve initially has a flattened state.

122. The method of claim 110 wherein, in the step of providing a sleeve, the lower portion of the sleeve is further defined as comprising a base portion and a skirt portion extending from at least a portion of the base portion.

123. The method of claim 122 wherein the upper portion extends from at least a portion of the skirt portion of the lower portion of the sleeve.

124. The method of claim 122 wherein the upper portion extends from at least a portion of the base portion of the lower portion of the sleeve.

125. The method of claim 110 wherein, in the step of providing a sleeve, the upper portion is sized to substantially surround at least a portion of a floral grouping disposed within a flower pot disposed in the sleeve.

126. The method of claim 110 further comprising the step of detaching the upper portion of the sleeve from the lower portion of the sleeve along the detaching element after disposing at least one of a floral grouping, flower pot, botanical item, propagule and growing medium in the sleeve, wherein the upper edge of the lower portion of the sleeve is provided with the appearance of having the configuration of the upper boundary of the decorative pattern or color.

127. The method of claim 110 further comprising the step of detaching the upper portion of the sleeve from the lower portion of the sleeve along the detaching element before disposing at least one of a floral grouping, flower pot, botanical item, propagule and growing medium in the sleeve, wherein the upper edge of the lower portion of the sleeve is provided with the appearance of having the configuration of the upper boundary of the decorative pattern or color.

128. The method of claim 110 wherein, in the step of providing a sleeve, a clear zone is provided between the upper boundary of the decorative pattern or color and the upper edge of the lower portion of the sleeve.
